(19) United States
(12) Patent Application Publication
(10) Pub. No.: US 2002/0059091 A1
(43) Pub. Date: May 16, 2002

(54) Apparatus and methods for selecting farms to grow a crop of interest

(75) Inventors: Norman Hay, Orono, MN (US); John Jeffrey Schlachtenhaufen, Lake Forest, IL (US); James Francis Ulrich, Lake Forest, IL (US); Bruce H. Barnett, Lake Forest, IL (US); Robert Andrew Barclay, Hawthorn Woods, IL (US)

Correspondence Address: MARSHALL, O'TOOLE, GERSTEIN, MURRAY & BORUN, 6300 SEARS TOWER, 233 SOUTH WACKER DRIVE, CHICAGO, IL, 60606-6402, US

(73) Assignee: Renessen LLC

(21) Appl. No.: 10/043,403

(22) Filed: Jan. 10, 2002

Related U.S. Application Data
(62) Division of application No. 09/626,576, filed on Jul. 27, 2000.
(60) Provisional application No. 60/215,982, filed on Jul. 5, 2000.

(51) Int. Cl. G06F 17/60

(52) U.S. Cl. 705/8

(57) ABSTRACT

Apparatus and methods are provided for selecting farms to grow a crop of interest and/or for performing economic analysis relating to growing a crop of interest. One such disclosed apparatus includes a database and a farm identifier in communication with the database to develop a set of farms capable of growing the crop of interest. The apparatus also includes a competition analyzer cooperating with the farm identifier to estimate profits to be earned by farms in the set of farms for growing at least one crop which is different from the crop of interest. The apparatus is further provided with an offer developer cooperating with the competition analyzer to determine possible offers to be made to the farms in the set of farms based at least in part upon the estimated profits to be earned for growing the at least one crop which is different from the crop of interest. Additionally, the apparatus includes a farm selector cooperating with the offer developer to select farms from the set of farms to receive an offer to grow the crop of interest.

### RELATED APPLICATIONS

This patent claims priority from U.S. Provisional application Ser. No. 60/215,982filed Jul. 5, 2000, which is hereby incorporated by reference in its entirety.

### FIELD OF THE INVENTION

The invention relates generally to agriculture, and, more particularly, to apparatus and methods for selecting farmers and areas to grow a crop of interest and/or for performing economic analysis relating to such farms.

### BACKGROUND OF THE INVENTION

Today, most crops grown in the world are grown without a contract to purchase those crops. Instead, in the typical scenario, farmers simply decide which crop(s) to grow based on personal preferences, agronomic considerations (e.g., crop rotation, elevator requirements, etc.), and their expectations of future market conditions. The farmers then sell their crop(s) to a local elevator or loader which, in turn, sells the crop(s) on the market as commodities.

The agriculture system is, however, in a state of change. As technology has advanced, the possibility of growing new and/or improved specialty crops has arisen. Specialty crops can be developed by conventional breeding or genetic modification. Such specialty crops typically have traits that are superior to their commodity crop counterparts (e.g., quality bred corn could, for example, have 6% oil whereas unenhanced corn might have 2%-4% oil). These enhanced or new traits give such specialty crops added value in comparison to their traditional counterparts. The advent of these specialty crops has provided farmers around the world with a wider range of crop choices and added a new level of complexity and variety to the agriculture industry. This complexity will likely increase as technology advances and new techniques such as stacking traits within one seed come into widespread use. Additionally, technological advances in the animal producing field (e.g., quality breeding, transgenetic techniques, etc.) are producing a similar increased variety of options from the animal husbandry point of view. Since crops are one possible input to animal production, the advances in the animal production art will impact on the crop producing field and vice versa thereby creating still another layer of complexity.

Producers of differentiated products (e.g., germplasm, crop protection chemistries, fertilizer, etc.) have a substantial interest in placing their products with farmers who will succeed in using those products. As a result of this interest, it is likely that contract farming will increase in popularity in the coming years. Contract farming refers to situations in which a farmer contracts with a third party to grow crop(s) of a designated type. The third party in this scenario can be any type of entity such as a specialty product provider (e.g., a specialty grain company, a biotechnology company involved in development of specialty traits, and/or a germplasm provider), an animal producer (e.g., a chicken farmer, a cattle rancher, etc.), a food processing entity (e.g., a producer of canned vegetables, soup, and/or processed meat products) and/or other input providers. In short, the increasing availability of specialty crops is likely to lead to increasing levels of contract farming and complexity and, thus, greater integration in the agriculture system.

As contract farming becomes more popular, contracting entities such as, for example, agricultural entities (e.g., any provider of supplies or support for agronomic activity such as crop protection products, seeds, fertilizers, seedlings, plants, etc.) will have increasing incentive to minimize risk and identify preferred potential contracting partners (e.g., farmers in preferred geographic locations, etc.).

### BRIEF DESCRIPTION OF THE DRAWINGS

FIG. 1 is a schematic illustration of an apparatus constructed in accordance with the teachings of the instant invention and shown in a preferred environment of use.

FIG. 2 is a more detailed view of the apparatus of FIG. 1.

FIG. 3 is a more detailed view of the farm identifier of FIG. 2.

FIG. 4 is a more detailed view of the competition analyzer of FIG. 2.

FIG. 5 is a more detailed view of the offer developer of FIG. 2.

FIG. 6 is a more detailed view of the farm selector of FIG. 2.

FIGS. 7A-7B are flowcharts illustrating an example program for implementing the apparatus of FIG. 1.

FIG. 8 illustrates an example sales forecast table.

FIGS. 9A-9B are a flowchart illustrating an example program for implementing the farm identifier and the competition analyzer of FIG. 2.

FIG. 10 illustrates sample transportation market prices tables.

FIG. 11 illustrates an example product market prices table.

FIG. 12 is a flowchart illustrating an example program for implementing the offer developer of FIG. 2.

FIG. 13 is a flowchart illustrating an example program for implementing the farm selector of FIG. 2.

FIG. 14 is a flowchart illustrating one possible use of the crop planner of FIG. 2 for performing economic analysis.

FIG. 15 is a flowchart illustrating another possible use of the crop planner of FIG. 2 for performing economic analysis.

### DESCRIPTION OF THE PREFERRED EMBODIMENTS

Overview

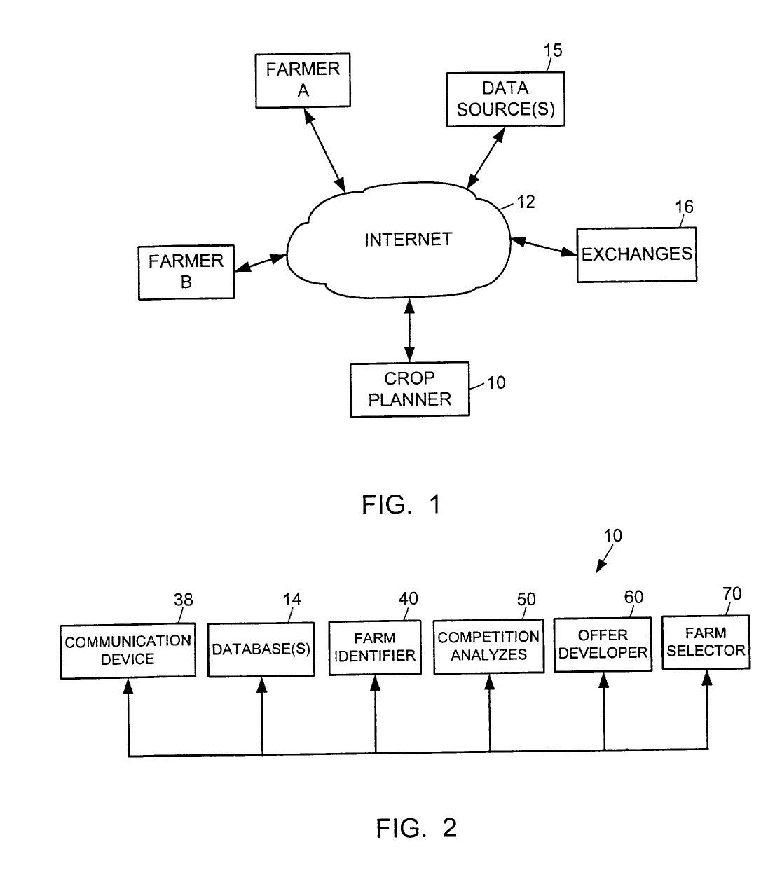

A crop planning apparatus 10 constructed in accordance with the teachings of the invention is shown in FIG. 1 in a preferred environment of use, namely, connected to the Internet 12. However, while the crop planner 10 is preferably used with the Internet, persons of ordinary skill in the art will readily appreciate that the crop planner 10 is not limited to use with any particular environment of use. On the contrary, the crop planner 10 can be used in any environment that would benefit from its capabilities.

The disclosed crop planner 10 provides a tool for enabling an agricultural entity such as a specialty product provider to (i) identify preferred farms to contract with to produce crop(s) of interest; (ii) to price their contracts at a level that maximizes profits to the specialty product provider while ensuring adequate profits to the farm(s) and acceptable pricing to the consumer; (iii) to reduce and/or minimize risk to the specialty product provider; and (iv) to perform additional economic analysis relating to crop production. To achieve these and other ends, the crop planner 10 is premised on the following economic assumptions.

With respect to farms, it is assumed that, to get farms to grow the product of interest, the farms must be offered a price which gives them at least as much profit as other crops they can grow. These competing crops do not have to be replacements in any consumption or use sense for the product(s) of interest to the crop planner 10. Instead, these competing crops include any crop that competes for the farmer's land. Further, it is assumed that profit to the farmer, not revenue or unit price, is the deciding factor for selecting between crops from the farmer's perspective. Thus, a model for determining expected farmer profit is required by the crop planner 10.

With respect to buyers (e.g., consumers), it is assumed that, to get buyers interested in the product, they must be offered the lowest price possible which is consistent with other objectives (e.g., being able to get farms to produce, and taking into account the next assumption).

With respect to agricultural entities such as specialty product providers, it is assumed that such entities interested in contracting with farmers need to make a profit. Additionally, it is assumed that such entities wish to minimize their risk. Thus, the process of identifying a preferred set of farms to grow the crop of interest is not simply a “lowest cost” determination, but is instead a “best value” determination, where value takes into account both cost and risk.

In keeping with the foregoing assumptions, the crop planner 10 can preferably be operated as follows. A data set which contains the expected sales volumes of a specialty product provider, by product by month and by destination customer is created. The destination information also includes the nature of the destination facility for unload, such as unload speeds, unloading structure types, number of rail cars that can be accommodated, and any other pertinent data.

A data set containing all the loaders and elevators in the region of interest is then accessed. This data set includes information such as elevator/loader location, type, structure (e.g., number of bins, loading speeds, types of dryer, etc.), and any other pertinent data.

The crop planner 10 also accesses, preferably in real time, the transportation market to find the costs of transport from each elevator and/or loader to each of the destination customer points identified in the sales data set. Preferably, the crop planner 10 eliminates some elevators and/or loaders from consideration at this stage, perhaps on grounds of loading speed or number of rail cars that could be loaded at one time which does not fit the destination requirements.

The crop planner 10 also accesses data on competitor products and the level of bids that competitors are making to get their products grown around these particular elevators and/or loaders. An example of such a competitive bid is, DuPont bidding farms in the hinterland of elevator A at 20 cents a bushel premium over commodity corn for its high oil corn variety. In this way, the crop planner 10 creates a picture of the competitive landscape for these products.

The crop planner 10 also accesses a farmer database for each of the elevators and/or loaders. This database comprises information about the size of farm, acreage under crop, land use, soil type, fertilizer type, rotation situation, land value, cropping practice, etc., which is needed to calculate a revenue model for this particular farm.

Then, for each of the farms, the crop planner 10 inputs the competitive bids for different products into the revenue model in order to calculate the per acre revenue effect of these different products. Based on this competitive data, the crop planner 10 calculates the level at which the specialty product provider would have to bid in order to get the product of interest grown on that particular farm acre.

Using this bid level for the product of interest, the crop planner 10 calculates the delivered cost (farmer cost plus storage cost plus transportation cost) of the product to the customer factory. Then, based on predetermined criteria, the crop planner 10 identifies the elevators and/or loaders which meet the requirements for growing the product of interest. One of these criteria is volume (how many elevators and, thus, farmers are needed to meet the sales targets). Another such criterion is an assessment of the riskiness of growing crops at a particular elevator and/or loader location because of, for example, weather factors.

Based on this limited set of elevators and/or loaders, the crop planner 10 then accesses the farmer growing data set and identifies the farmers who meet a set of predetermined criteria for getting the product of interest grown. Preferably after human approval, the crop planner 10 then makes contract offerings to the identified farmers. Should the initial farmers chosen not meet the criteria (e.g., of volume), then the crop planner 10 goes to the next best alternative elevators and/or farmers.

In this way, the crop planner offers a way for a specialty product provider to calculate the competitive landscape, to price its product, and to identify the optimum area(s) for that provider to get its products grown with respect to the sales projected for these products.

Detailed Example

A more detailed illustration of the crop planner 10 is shown in FIG. 2. In order to provide the crop planner 10 with access to the data it needs to function, the crop planner 10 is provided with one or more databases 14. The database(s) 14 can be local (e.g., implemented on a mass storage device such as a hard drive of a local computer), and/or remote (e.g., located remote from the crop planner 10 but accessible via a computer network such as the Internet 12). In the case of remote database(s), the database can be on-line, accessible through some other off-line connection, or accessible via another data transfer medium (e.g., a compact disk or DVD sent through the mail service or via a courier). Moreover, on-line database(s) 12 can be implemented by traditional database structures 15 of any format, or structures less conventionally thought of as databases such as on-line market exchanges 16 (see FIG. 1).

Regardless of whether such databases 14, 15, 16 are local or remote, on-line or off-line, or a mixture thereof, the database(s) 14, 15, 16 preferably include (a) a product database 20 containing data indicative of types of products that may be grown by a plurality of farms, (b) an elevator database 22 containing data indicative of types and quantities of products that may be handled by one or more elevators; (c) a loader database 24 containing data indicative of types and quantities of products that may be handled by one or more loaders; (d) a product market database 26 containing data indicative of sales prices of types of products; (e) a transportation market database 28 containing data indicative of transportation costs for transporting goods between geographic locations; (f) a transportation database 30 containing data indicative of types of transportation available for transporting a product from at least one of a farm, an elevator and a loader; and (g) a farm database 32 containing data indicative of at least one of (i) agronomic characteristics of a farm and (ii) geographic information concerning a farm. The farm database 32 is preferably a database of all farmers particularly those who might wish to contract, have contracted, or are existing contract partners of the agricultural entity of interest. The farm database 32 preferably contains data indicative of characteristics of individual farms such as farm location, acreage, type, soil type, soil structure, climate, farming practice(s), crop practice(s), rotation schedule(s), and/or other information of interest to the crop planner 10. The elevator and loader databases 22, 24 (which, of course, may optionally be one database), preferably contain data indicative of characteristics of the loaders and/or elevators such as location, spacial structure, transportation mechanisms, storage structure, and other information of interest to the crop planner 10. The transportation database 30 preferably contains data indicative of all relevant transport information such as rail, barge, truck, etc., that pertains to the transport structure of a particular county or region of interest. The product market database 26 and the transportation market database 28 are preferably implemented by on-line exchanges 16. The product market database/exchange(s) 26 preferably include any exchange (e.g., for crops, crop residues, processed or unprocessed residues, rations, etc.) that exist today or may exist in the future. Additionally, the databases 14, 15 may also include actuarial tables indicative of risk probabilities associated with, for example, growing crops in certain areas, using a certain loader and/or elevator, growing crops at certain farms, weather risks, etc.

Any of the databases can be populated by robots or software agents programmed to locate and return data of interest via the internet.

To enable access to data located at off-line, and/or on-line database(s) 15, 16, the crop planning apparatus 10 is preferably provided with a communication device 38. The communication device 38 can be implemented by, for example, a modem and/or a satellite dish without departing from the scope or spirit of the invention.

For the purpose of developing a set of farms capable of growing a crop of interest from the farms identified in the database(s) 14, 15, the crop planner 10 is further provided with a farm identifier 40. As shown in FIG. 2, the farm identifier 40 is preferably in communication with the local database 14, and may also be in communication with one or more remote databases 15, 16 via the communication device 38. Preferably, the farm identifier 40 identifies the set of farms based upon at least one of: (a) elevator capability to handle the crop of interest; (b) loader capability to handle the crop of interest; (c) farm capability to grow the crop of interest; (d) farm capability to grow a predefined quantity of the crop of interest, and (e) farm capability to grow the crop of interest within a predetermined schedule.

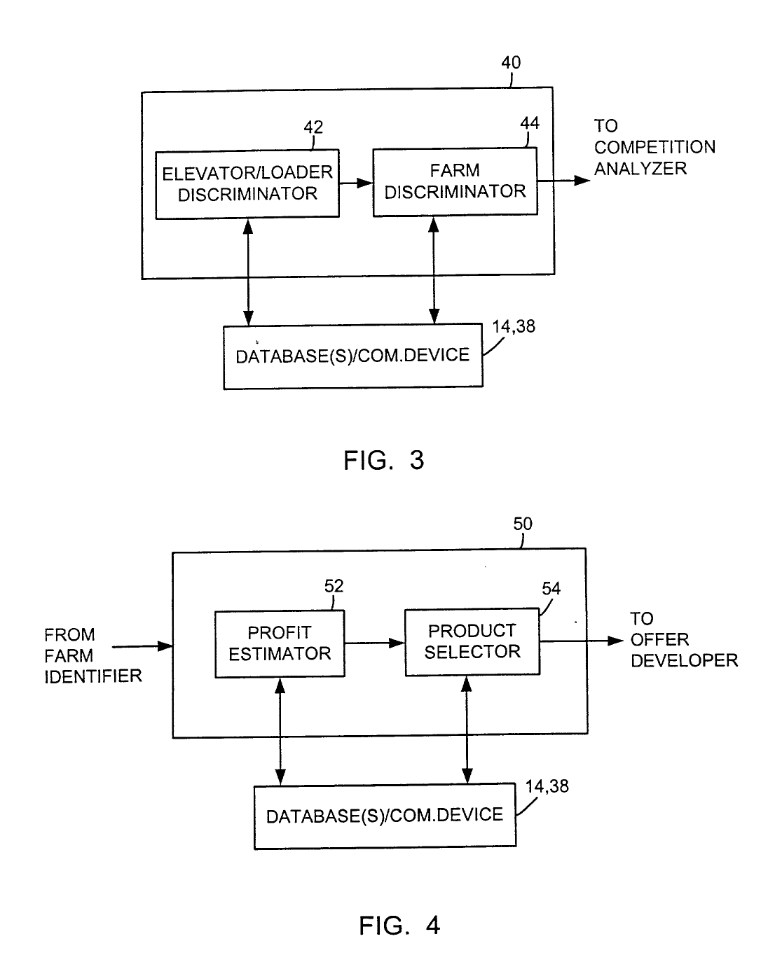

A more detailed view of the farm identifier 40 is shown in FIG. 3. As shown in that figure, the farm identifier 40 preferably includes an elevator/loader discriminator 42 and a farm discriminator 44. The elevator/loader discriminator 42 identifies elevator/loaders that cannot handle the crop of interest to the agricultured entity operating the crop planner 10. The elevator/loader discriminator 42 preferably performs this operation by accessing the data in the elevator and/or loader database(s) 22, 24 and comparing it to the business objectives (e.g., type of crop, quantity of crop, and delivery schedule) of the agricultural entity to identify those elevators/loaders that cannot advance the objectives of the agricultured entity in a meaningful way.

The farm discriminator 44, on the other hand, cooperates with the elevator/loader discriminator 42 to eliminate farms from the set of farms under consideration for growing the crop of interest. The farm discriminator 44 eliminates those farms that (i) are associated with only elevators and/or loaders identified by the elevator/loader discriminator 42 as incapable of handling the crop of interest, and/or (ii) are otherwise incapable of growing the crop of interest. The elimination of such farms is performed by accessing data in the farm database 32 and comparing it to the business objectives of the agricultural entity at issue. The output of the farm identifier 40 is preferably a subset of farms capable of growing the crop of interest.

The crop planner 10 is further provided with a competition analyzer 50. As shown in FIG. 2, the competition analyzer 50 is preferably in communication with the local database 14, and may also be in communication with one or more remote databases 15, 16 via the communication device 38. The competition analyzer 50 estimates profits to be earned by farms in the subset of farms developed by the farm identifier 40 for growing at least one crop which is different from the crop of interest. As mentioned above, a farmer will likely seek to maximize his/her profits within the constraints of his/her farm. Thus, subject to crop rotation requirements, a farmer is likely to plant the crop with the largest profit margin. Thus, if an agricultural entity such as a specialty product provider wishes to contract with that farmer to plant a specific crop, the agricultural entity must price the return to the farmer at a level sufficient to interest the farmer, namely, at a level competitive with the alternative crops the farmer can grow. The competition analyzer 50 performs the analysis needed to identify the profit alternatives available to the farmer for later use by the crop planner 10 in developing the offer to be made to the farmer.

As shown in FIG. 4, the competition analyzer 50 includes a profit estimator 52 and a product selector 54. For each of the farmers in the set of farms developed by the farm identifier 40, the profit estimator 52 estimates a profit the farmer can expect to earn by growing crop(s) different from the crop of interest. The profit estimator 52 performs this analysis by accessing the farm database 32 to determine the types and quantities of the alternative crops which the farm can grow and by accessing the product market database 26 (which is preferably implemented by one or more exchanges 16 contacted via the communication device 38) or by utilizing robotic devices to seek out real time current competitive bids being posted at particular elevator(s)/loader(s) to determine the current market price(s) for the subject crop(s) (preferably in real-time). Armed with this information, the profit estimator 52 calculates the estimated profit(s) the farm can achieve for each competitive product the farm can grow based on stored information relating to that farm and/or estimated information based on profiling (e.g., comparing the demographic profile of the farm of interest to a corresponding baseline farm profile in a table of farm profiles).

Once the competitive profit(s) of the competing crop(s) are determined, the product selector 54 compares the profits of the alternative crops to identify the most profitable competitive crop for the farm. The result of the comparison is saved for later use by the crop planner 10. (The result includes the top several competitive crops and their associated profits to the farmer). The profit estimator 52 and the product selector 54 cooperate to identify the most profitable competing crop for each farm capable of growing the crop of interest to the agriculture entity.

To determine possible offers to be made to the farms in the set of farms capable of growing the crop of interest, the crop planner 10 is further provided with an offer developer 60. As shown in FIG. 2, the offer developer 60 is preferably in communication with the local database 14, and may also be in communication with one or more remote databases 15, 16 via the communication device 38. The offer developer 60 determines the possible offers based at least partially upon the estimated profits to be earned for growing the crop(s) competing with the crop of interest as calculated by the competition analyzer 50. Preferably, the offer developer 60 also bases the possible offers on risk factor(s) and profits to be earned by the agricultural entity by growing the crop of interest.

With respect to the latter factor, the agricultural entity will likely not want to contract with farms at a price that will result in a small positive, zero or negative profit for the agricultural entity. If, after completing the analysis across all farms, the crop planner 10 determines that the price required to compete with the most profitable crop of the farms is too high to ensure a reasonable profit to the agricultural entity at a reasonable price to the consumer, the crop planner 10 may be adapted to re-execute by using the second most profitable competing crop of the farms. (Farms will often grow more than one crop type to hedge against market downturns and crop failure, and to facilitate crop rotation practices). This process can be repeated (e.g., with the third most profitable crop, etc.) until the agricultured entity arrives at a plan that meets with their economic goals and expectations.

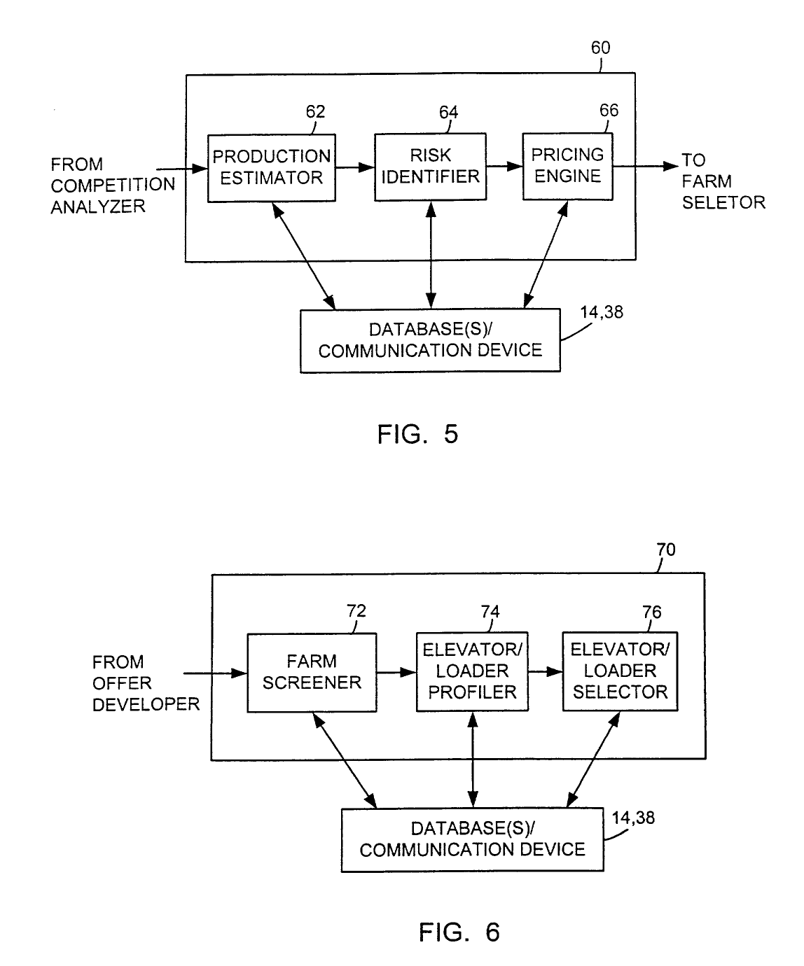

A more detailed view of the offer developer 60 is shown in FIG. 5. As shown in that figure, the offer developer 60 preferably includes a production estimator 62, a risk identifier 64 and a pricing engine 66. The production estimator 62 estimates a quantity of the crop of interest to the agricultural entity that can be produced by a given farm. This estimation is performed based in part on the output of the competition analyzer 50. In particular, the production estimator 62 accesses the farm database 32 to determine the amount of acreage that is expected to be under crop for the crop competing for the land of interest (typically, the most profitable crop identified by the competition analyzer 50 for the farm in question, but possibly a less profitable crop as explained above). Then, based on that acreage, and the expected per acre yield of the crop of interest to the agricultural entity, the production estimator 62 determines the quantity of the crop of interest that the subject farm can produce (i.e., available acreage * yield per acre=expected production).

The risk identifier 64 accesses a database of risk factors to identify risk factor(s) associated with the farm of interest. Risk factor(s) identified by the risk identifier 64 can be agronomic in nature (e.g., weather related, farmer yield history, etc.) and/or financial in nature (e.g., farmer credit history). Examples of risk factor include climate risk, farmer performance risk, yield risk, and competition risk. The risk factor data is developed from historical agricultural data. The risk factor data is valued using well known actuarial analysis.

The pricing engine 66 cooperates with the production estimator 62 and the risk identifier 64 to develop price(s) to be offered the farm(s) to grow the crop of interest to the agricultural entity. For each farm, the pricing engine 66 develops the price to be offered based upon: (a) the expected yield of the subject farm, (b) the risk factor(s) for the subject farm, (c) the customer market price expected to be earned by the product of interest; (d) the profit to be earned by the farm for the competing product, and (e) the profit to be earned by the agricultural entity. Thus, the pricing engine calculates the price at which the farm(s) of interest would have a financial incentive to grow the crop of interest taking into account any premiums to be provided by the agricultural entity based upon the preceding factors (a) through (e). If a farm under analysis is associated with more than one elevator and/or loader, the offer developer 60 preferably determines the possible offer based upon the elevator/loader that will enable that farm to earn the highest profit.

The output of the offer developer 60 is preferably a set of possible offers that could be made to farms capable of growing the crop of interest. Such possible offers preferably specify the amount of acreage, the expected yield and the price to offer the farmer. Preferably, one possible offer is saved in association with each farm capable of growing the crop of interest.

Returning to FIG. 2, for the purpose of selecting farms to receive an offer to grow the crop of interest to the agricultural entity executing the crop planner 10, the crop planner 10 is further provided with a farm selector 70. As shown in FIG. 2, the farm selector 70 is preferably in communication with the local database 14, and may also be in communication with one or more remote databases 15, 16 via the communication device 38. The farm selector 70 accesses these databases in making its selection. In particular, the farm selector 70 preferably selects farms based upon (i) the offers developed by the offer developer 60; (ii) risk estimations associated with the farms in the set of farms selected by the farm identifier 40; (iii) profits to be earned by the agricultural company; (iv) prices to be charged consumers; (v) transportation costs for transporting the crop of interest from a farm to a predefined location; (vi) transportation costs for transporting the crop of interest from a farm to a loader; (vii) transportation costs for transporting the crop of interest from a farm to an elevator; (viii) transportation costs for transporting the crop of interest from an elevator to the predefined location; (ix) transportation costs for transporting the crop of interest from a loader to the predefined location; (x) aggregate economic profiles of elevators associated with the farms in the set of farms; and; (xi) aggregate economic profiles of loaders associated with the farms in the set of farms.

Preferably, the farm selector 70 includes a farm screener 72, an elevator/loader profiler 74, and an elevator/loader selector 76 as shown in FIG. 6. The farm screener 72 is in communication with the database(s) 14, 15, 16 and selects a preferred set of farms based on the data retrieved therefrom which includes data developed by the farm identifier 70, the competition analyzer 50, and/or the offer developer 60. The selection made by the farm screener 72 is preferably based on the factors mentioned above such as risk factor(s), expected profit(s) and/or expected quantities.

The elevator/loader profiler 74, develops an aggregate economic profile for each elevator and/or loader associated with a farm in the preferred set of farms developed by the farm screener 72. The aggregate profile of each of the elevators/loaders is preferably based upon cost and risk factors associated with the farms associated with the subject elevator/loader. The profiler also relies upon tables covering the elevator/loader's historical performance based upon a variety of relevant factors (e.g., moisture control and split bins). In other words, the aggregate profile of an elevator/loader is developed by combining the cost/risk profile data of those farms serviced by that elevator/loader which are included in the preferred set identified by the farm screener. For example, the profiler could accumulate information relating to the elevator/loader's: (1) experience in receiving/delivering high quality grain, (2) capabilities to identity preserve grain, (3) reliability, and, (4) ability to handle large volumes. Factors like these, together with the performance of the associated farms, would be summed by the elevator/loader profiler. Each of the summed factors is preferably converted into an average or otherwise normalized to permit comparison of the profiles of elevators/loaders servicing different numbers of farms.

The elevator/loader selector 76 selects farms to receive an offer to grow the crop of interest based on the aggregate economic profiles developed by the elevator/loader profiler 74 and the quantity of the crop of interest to be grown. This selection is performed by comparing the aggregate profiles of the elevator/loaders to identify the best elevator(s)/loader(s) from a cost and risk perspective, and then by selecting the best farm(s) from the farms associated with the selected elevators/loaders up to the desired quantity of the crop of interest, or, alternatively, up to the desired monetary value to spend contracting to grow the crop of interest.

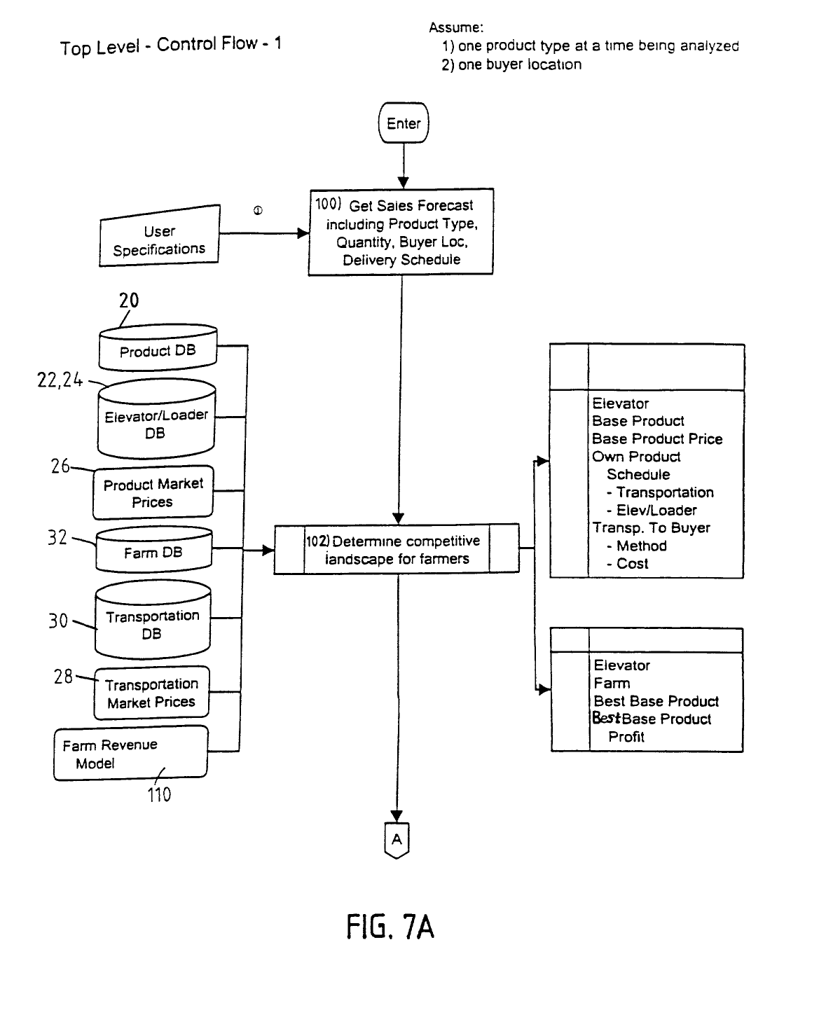

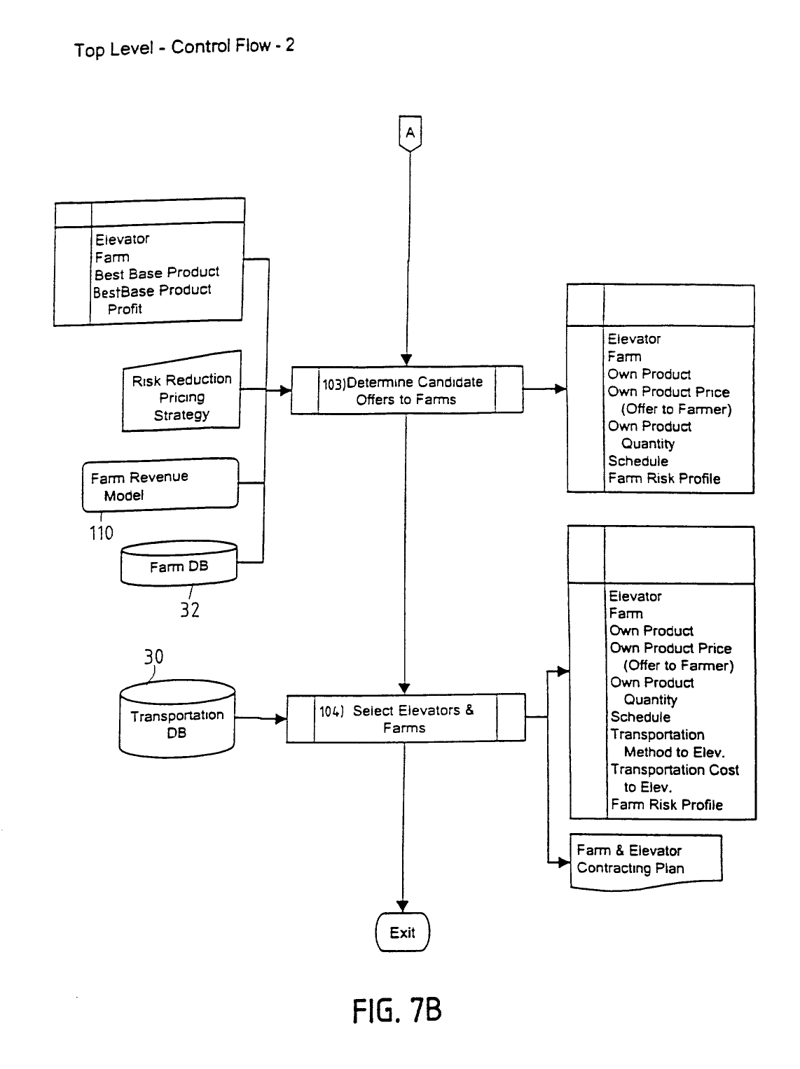

Although, as will be appreciated by persons of ordinary skill in the art, the crop planning apparatus 10 can be implemented in whole or in part by hardware, firmware, and/or software without departing from the scope or spirit of the invention, the crop planner 10 is preferable implemented by software executing on a computer. The preferred software implementation will now be described with reference to FIGS. 7-13.

Note: Throughout FIGS. 7-13, both elevators and loaders are considered, although in some cases just the term “elevator” may appear due to space considerations.

Software Overview

As mentioned above, the crop planner 10 is implemented with several purposes in mind. First, it is designed to determine the acreage which will be good choices for growing crops of interest to a party interested in, for example, contracting to grow such crops. This determination preferably takes into account logistics (e.g., transportation costs, elevator availability and costs). Additionally, the crop planner 10 is implemented to assist in determining offers which will be sufficiently attractive to farmers to persuade them to grow the crop of interest rather than something else. As will be discussed below, the crop planner 10 can also be used as a tool to perform economic analysis.

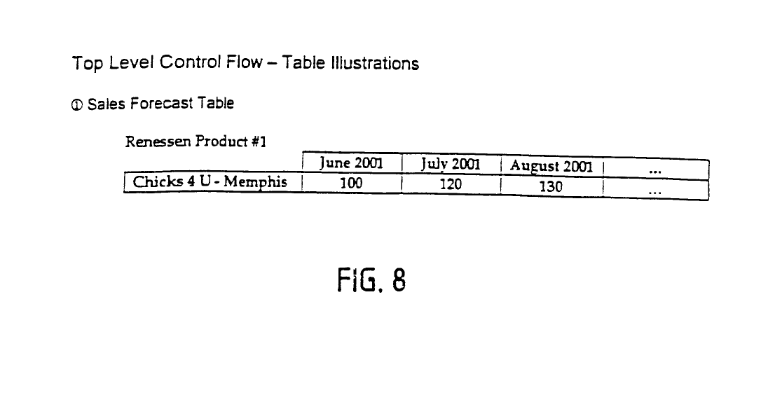

An overview of an example program for implementing the crop planner 10 is shown in FIGS. 7A-7B. As shown in FIG. 7A, the crop planner 10 first determines the problem to be solved by accepting inputs identifying the crop of interest, the quantity of the crop of interest the agricultural entity would like to sell, the location of the buyers of the crop of interest, characteristics of agronomy particular to such crop growth (for instance, optimum soil types and/or climate considerations), desired storage facilities (e.g., on farm, or in elevator (county or terminal)), required storage conditions, storage length limitations, delivery requirements (e.g., types of transportation)), and the delivery schedule for the crop of interest (block 100). This information is preferably included in a sales forecast table such as the exemplary table shown in FIG. 8. Alternatively, the information can be entered through a query and input type system.

In addition to the sales forecast table, farms and elevators/loaders to be included or excluded from consideration can optionally be input at this time. This block 100 supports repeated analysis, refining a solution or limiting the size of the solution space.

Once the data necessary to define the business objectives to be pursued by the crop planner 10 is entered, the farm identifier 40 and the competition analyzer 50 of the crop planner 10 access the product database 20, the elevator/loader database 22, 24, the product market prices database 26, the transportation market prices database 28, the transportation database 30, and the farm database 32, and use the data retrieved therefrom to respectively identify the farms capable of growing the crop of interest and to estimate the profits each such farm can attain for other products it might grow (block 200). The farms capable of growing the product of interest and the “competing” products for each such farm are determined from what the elevators/loaders “servicing” each such farm will purchase. As explained below, other factors are also considered in the farm capability determination.

In order to estimate the profits for growing competing products, the crop planner 10 must include a model 1 10 for calculating the expected revenue of the farms. The farm revenue model 1 10 preferably accesses the farm database 32 to determine farm specific data such as acreage, crops grown in the past, crop rotation schedule, acreage under crop, available acreage (at present and in future), transportation infrastructure, elevator/loader affiliation(s), and related costs (e.g., fertilizer, equipment, etc). Based on this data as well as current market prices data (which could include futures market data) retrieved from the product market database 26 via the communications device 38, the farm revenue model 110 calculates the expected costs for growing each possible competing crop and the expected revenue for growing each such crop. The expected profit for growing each crop is then calculated by subtracting the estimated costs from the estimated revenues for each competing crop the farm could produce.

Models for calculating the expected profits of a farm are currently available to farmers as a planning tool. Examples of such revenue models includes the product referred to as MARKETEER that is available from the University of Minnesota website (http ://www.cffin.umn.edu/software/Marketeer/Default.htm). Another such product is sold under the tradename FARM-ASSIST by ZENEC AG PRODUCTS (see http://www.farm-assist.com). Any of those models can be used to implement the farm revenue model 110.

After the estimated profits for the competing products that can possibly be grown by the farms are calculated, at block 103 (FIG. 7B) the offer developer 60 determines the prices (i.e., the product prices at the elevator) to offer the farmers for growing the product of interest (“own product”). The offer developer 60 takes into account the level of profit for each farmer for competing products, and any premium to be offered to the farmer to encourage acceptance of the offer. For example, farmers who are lower risk may be offered a higher premium.

After the possible offers are calculated, at block 104 the farm selector 70 performs the combined selection of farms and elevators/loaders to receive offers. As opposed to block 103, block 104 is performed from the viewpoint of buyers and the agronomic entity (e.g., a germplasm producer) seeking to contract with farmers. The selection is made to keep the price to the buyer down while also considering the overall risk profile of being able to deliver the product, and the profit to be attained by the agronomic entity.

The Farm Identifier and Competition Analyzer

As mentioned above, the farm identifier 40 and the competition analyzer 50 cooperate to determine the competition for the farmer's business (e.g., other crops that can be grown, and the profit associated with them).

Since some farms can be served by more than one elevator/loader, the competition analyzer 50 iterates through the elevators/loaders, determining those which are reasonable to consider. For those which pass this test, the prices of the products handled by the elevator/loader are obtained. From the farmer's viewpoint, this is the set of competing products which the farm might produce. Then, for each farm served by the elevator/loader, the farm revenue model 110 is run to determine the farmer's return for each competing product.

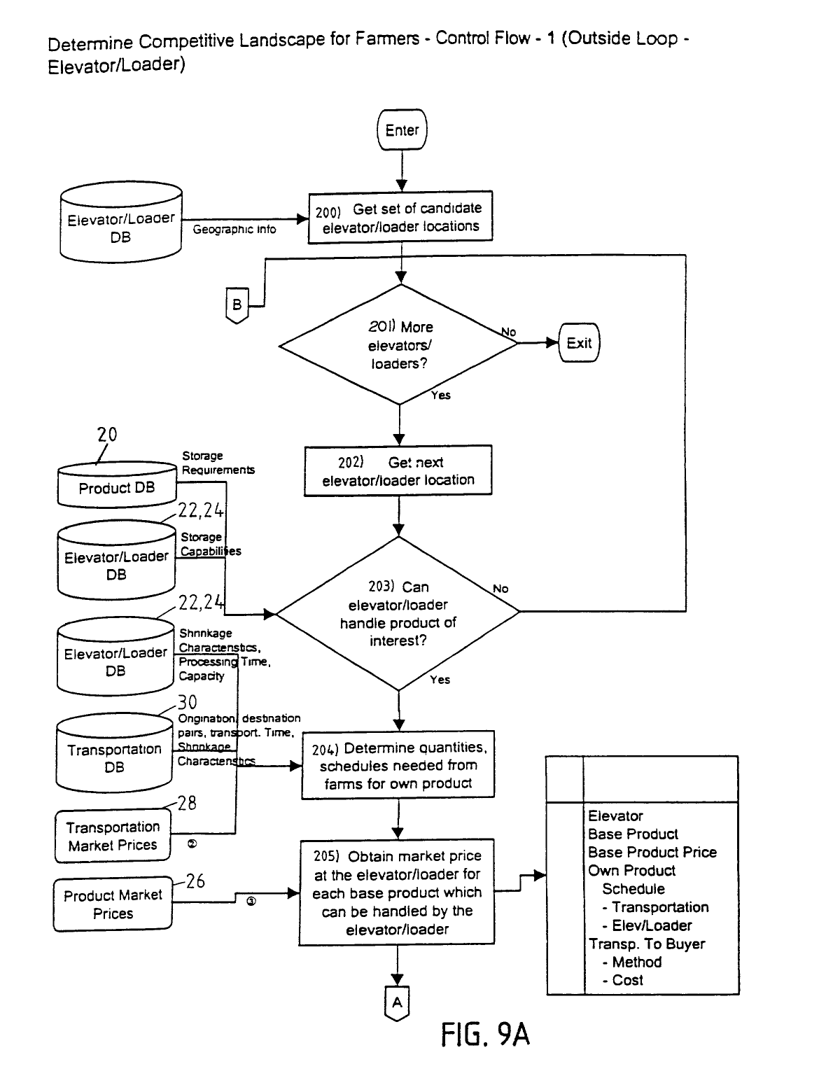

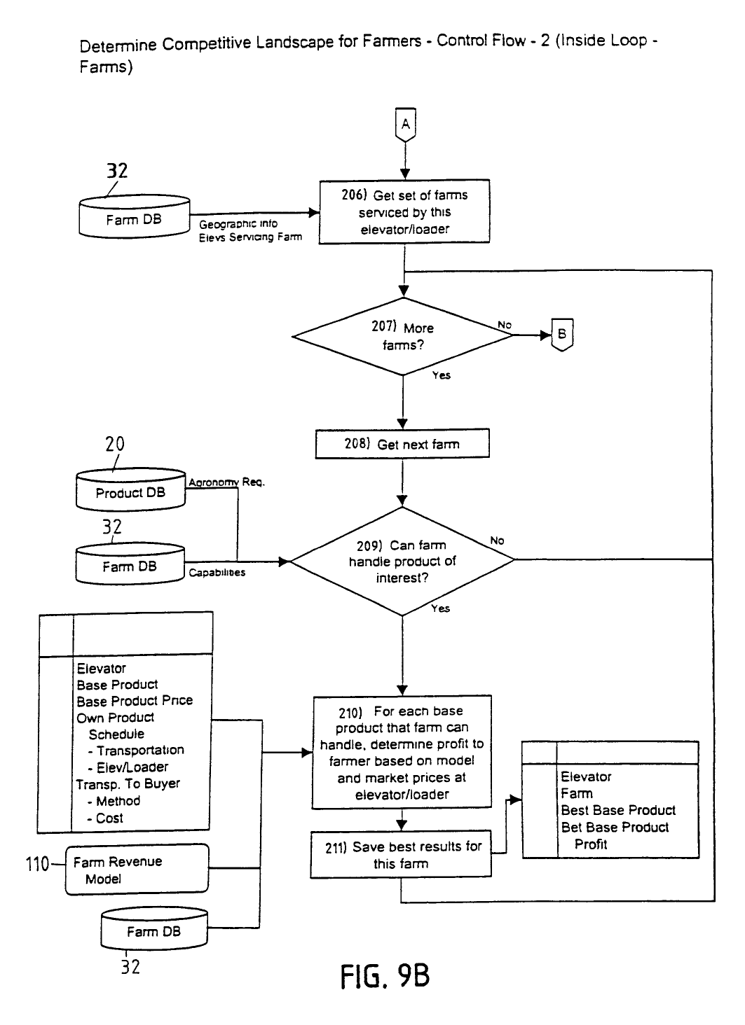

An exemplary program for implementing the farm identifier 40 and the competition analyzer 50 is shown in FIGS. 9A-9B. The program of FIGS. 9A-9B corresponds to block 102 of FIG. 7A.

In performing its work, the program of FIGS. 9A-9B also determines items of interest to later processes. These items are collected and saved for later use. This may make the logic appear more complex than it needs to be, but is included for efficiency, to avoid doing some work multiple times.

At block 200, the elevator/loader discriminator 42 of the farm identifier 40 retrieves an initial set of candidate elevators/loaders from the elevator/loader database(s) 22, 24. During the retrieval, the elevator/loader discriminator 42 may optionally perform some filtering of the elevators/loaders based, for example, upon geographic location, using specifications gathered in block 100 of FIG. 7A. Other filtering occurs later in the program. A special elevator/loader entry, the “null” elevator/loader, is included to account for “direct to the buyer” transactions.

Blocks 201 and 202 control iterating through each of the retrieved elevators/loaders. Specifically, at block 201, the elevator/loader discriminator 42 of the farm identifier 40 determines if there are any elevators or loaders in the set of candidate elevators/loaders that have not yet been analyzed. If not, the elevator/loader discriminator 42 returns control to block 103 of FIG. 7B. Otherwise, control proceeds to block 202 where the next elevator/loader is identified for analysis.

At block 203, the elevator/loader discriminator 42 of the farm identifier 40 accesses the product database 20 and the elevator/loader database 22, 24 to obtain data indicative of the storage requirements of the crop of interest and the storage capabilities of the elevator/loader under consideration. If a comparison of the storage requirements and the storage capabilities reveals that the elevator/loader under consideration is incapable of handling the crop of interest within the confines of the delivery schedule specified in the sales forecast table, the elevator/loader discriminator 42 eliminates that elevator/loader from consideration. (Additional tests to eliminate elevators/loaders from consideration could optionally be inserted here.) It bears emphasis that the storage capability test is not strictly a storage quantity test since the quantity of the crop of interest to be delivered to the subject elevator/loader has not yet been determined. On the contrary, it is a test to see if the elevator/loader has the type of facilities required for handling the crop of interest, and has a predefined minimum available storage capacity at the time of interest based on the delivering schedule entered at block 100 of FIG. 7A. The latter determination is based on contractual obligation(s) of the elevator/loader and some minimum capacity to make that elevator/loader economically interesting to the agricultural entity executing the crop planner

After the capability of the elevator/loader is evaluated, control returns to block 201 where the next elevator/loader (if any) is identified. Control continues to loop through blocks 201-203 until all of the elevators/loaders in the set of candidate elevators/loaders have been considered or until a loader/elevator capable of handling the crop of interest is identified at block 203.

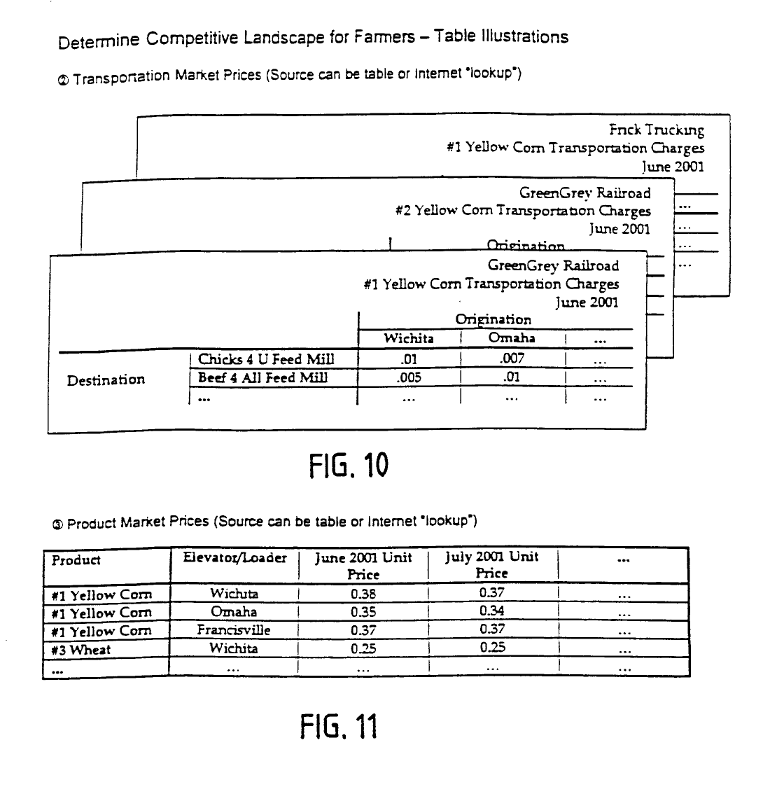

Assuming that an elevator or a loader capable of handling the crop of interest is identified at block 203, the farm discriminator 44 of the farm identifier 40 accesses the elevator/loader database 22, 24, the transportation database 30 and the transportation market prices database 28 to determine the delivery schedules, quantities, and costs expected throughout the logistics chain for the farm in question to meet the business objectives of the agricultural entity. As part of this process, the farm discriminator 44 determines possible transportation options from the elevator/loader to the buyer. Based upon the buyer schedule (see FIG. 8), transportation shrinkage, and transportation time, and other applicable limitations (e.g., destination can only handle so many trucks at one time), the farm discriminator 44 determines the product delivery schedule and quantity to the transportation system to support timely deliveries to the buyer. Based upon the elevator/loader logistics and shrinkage characteristics, the farm discriminator 44 also determines the product delivery schedule and quantity to the elevator/loader (from the farmer). Transportation costs are captured for use later. (See the exemplary tables of FIG. 10.) For the null (“direct to buyer”) elevator/loader, the farm discriminator 44 produces a schedule with instantaneous delivery, no shrinkage, and no cost.

At block 205, the competition analyzer 50 captures the price to the farmer of products which the farmer may choose to grow instead of the product of interest. The “product market prices” may come from online sources (e.g., an exchange 16), or from other data sources. A sample table of product prices is shown in FIG. 11.

Blocks 206 and 207 (FIG. 9B) control iterating through each of the farms associated with the elevator/loader under consideration. Specific, block 206, the farm discriminator 44 determines if there is a farm associated with the candidate elevator/loader that has not yet been analyzed. If not, control returns to block 201 of FIG. 9A. Otherwise, control proceeds to block 208 where the next farm is identified for analysis.

Assuming there is a farm that has not yet been analyzed, at block 208 the farm discrimination 44 accesses the product database 20 and the farm database 32 to obtain data indicative of the agronomic requirements of the crop of interest and the capabilities of the farm under consideration. If a comparison of the agronomic requirements and the capabilities of the farm reveals that the farm under consideration is incapable of handling the crop of interest within the confines of the delivery schedule specified in the sales forecast table, the farm discriminator 44 eliminates that farm from consideration. Control then returns to block 207 where the next farm (if any) is identified. Control continues to loop through blocks 207-209 until all of the farms in the set of candidate farms have been considered or until a farm capable of handling the crop of interest is identified at block 209.

In the case of the null elevator/loader, special selection rules are defined for use at block 209 (e.g., maximum geographic distance to the buyer).

Assuming that a farm capable of handling the crop of interest is identified at block 209, control proceeds to block 210. At block 210, the profit estimator 52 of the competition analyzer 50 determines the competitive landscape for an individual farm by considering prices available at the elevator(s)/loader(s) with which the farm is associated. For each competitive product which can be bought by the elevator, and which can be produced by the farm (determined via the farm database 32), the farm revenue model 10 is executed to estimate the profit the farm can make on those product(s). After each competitive product is analyzed for the subject farm, control proceeds to block 211.

At block 211, the product selector 54 of the competition analyzer 50 compares the expected profits developed at block 210 for each of the competitive products and stores the information on the best profit/product(s) for later use. The number of products stored is preferably kept small due to memory storage constraints, e.g., 1-3 products. Control then returns to block 207 where the farm discriminator 44 of the farm identifier 40 determines if more farms are available for consideration. Control continues to loop through blocks 207-211 until the best competitive profit/product(s) are identified for every farm capable of growing the crop of interest and associated with the current elevator/loader. When that process is completed, control returns to block 201 where the farm identifier 40 determines if more elevators or loaders are available for consideration. Control continues to loop through blocks 201-211 until the best competitive profit/product(s) are identified for every farm capable of growing the crop of interest and associated with an elevator/loader capable of handling the crop of interest. When that process is complete, control returns to block 103 of FIG. 7B.

The Offer Developer

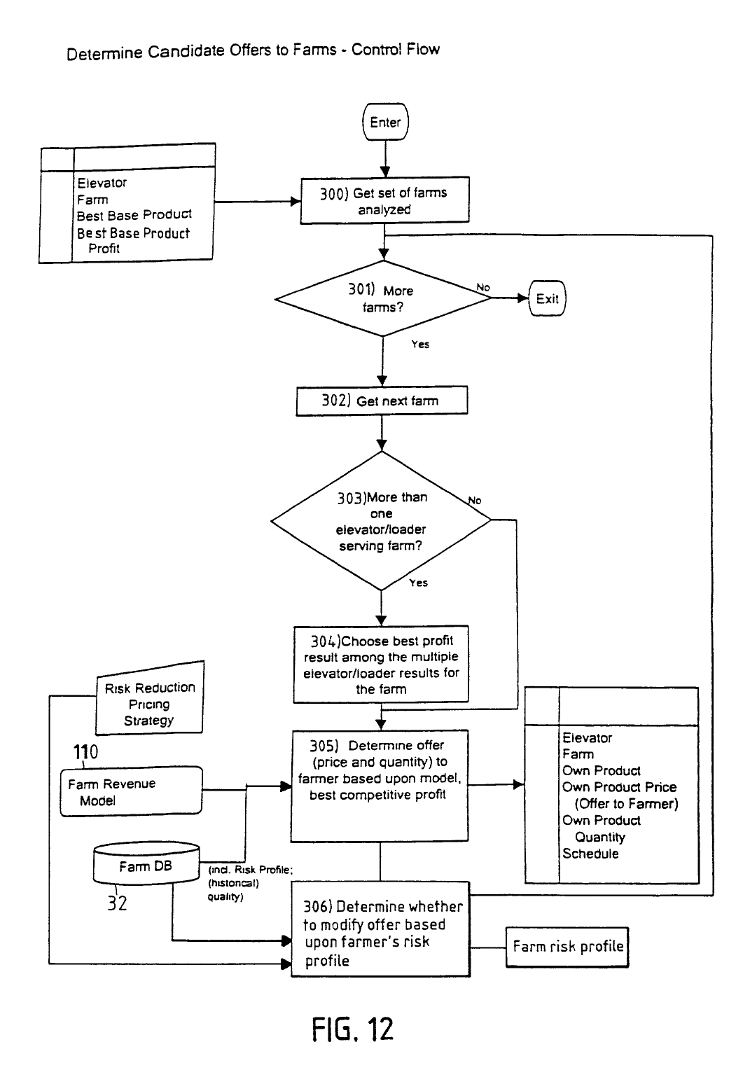

An exemplary program for implementing the offer developer 60 which determines the offer which will be made to a farm if that farm is selected to participate is shown in FIG. 12. This program corresponds to block 103 of FIG. 7B.

At block 300, the offer developer 60 accesses the set of farms identified by the farm identifier 40 and analyzed by the competition analyzer 50.

Blocks 301 and 302 control iterating through each of the farms in the set. Specifically, at block 301, the offer developer 60 determines if there are any farms in the set of candidate farms that have not yet been analyzed by the offer developer 60. If not, the offer developer 60 returns control to block 104 of FIG. 7B. Otherwise, control proceeds to block 302 where the next farm is identified for analysis.

In some cases a farm may be serviced by more than one elevator/loader (one of the options may be the null elevator/loader). At block 303, the offer developer 60 determines if the current farm is serviced by more than one elevator/loader. If there is only one elevator/loader for the farm, that elevator/loader and the highest profit/base product associated with the farm-elevator/loader pair is the best selection for the farm, and control proceeds to block 305. If there is more than one elevator/loader option for the farm (block 303), the offer developer 60 selects the elevator/loader which yields the best profit for the farm (block 304). This selection is made by comparing the estimated profits developed by the competition analyzer 50 for the subject farm for each of the elevator(s)/loader(s) with which the subject farm has an association.

Now knowing the profit that must be at least matched for the farm to consider producing the product of interest, the farm revenue model 10 is executed to determine the quantity of the crop of interest the farm can produce and a minimum price the farmer can be offered to interest him in growing the crop of interest (block 305). Execution of the farm revenue model 110 is performed using the input costs and constraints associated with the crop of interest to determine the expected yield of the farm and the expected total cost to the farm in producing that yield. The yield is determined by computing the amount of crop of interest that can be grown on the acreage the farm would otherwise use to grow the competing products. With the yield and cost known, the offer developer 60 can then determine a required price per unit to offer the farmer to at least equal the profit to be earned by the farmer for growing the best alternative crop. In other words, for the farmer to have an incentive to contract, gross revenue to the farm for growing the crop of interest less total costs incurred by the farm in that process should be greater than or equal to the competitive profit available to the farmer. Stated mathematically:

GR−C_{T}>P_{C}

where GR is gross revenue for growing the crop of interest, C_{T} is total cost for growing the crop of interest, and P_{C} is the profits to be earned by the farmer for growing the competitive product. Stated differently,

GR>P_{C}+C_{T}.

Since the product of price (T) and yield (Y) is equal to gross revenue (GR),

T*Y>P_{C}+C_{T}, or

T>(P_{C}+C_{T})Y

In other words, price (T) must be greater than or equal to the sum of the profit to the farmer for growing the competing product (P_{C}) and the total costs for growing the crop of interest (C_{T}), divided by the expected yield of the crop of interest (Y) for using the acreage otherwise used to grow the competing product. Since the farm revenue model 110 produces the expected yield and costs for the farm in question in growing the crop of interest, executing the farm revenue model 110 enables the offer developer 60 to use the above equation to subsequently calculate the price to be offered the farmer.

At block 306, the candidate offering price is preferably modified by the pricing engine 66 based upon a risk reduction pricing strategy (e.g., farms with a lower risk might be offered a premium on the price to encourage acceptance of the offer (increase the competitiveness of the offer); the size of the premium is preferably based upon the perceived degree of risk). The risk identifier 64 of the offer developer 60 makes this determination by accessing data in the farm database 32 indicative of the risk profile of the farm. The result (i.e., the competitive offer (e.g., price, quantity, delivery time) which could be made to the farm under consideration) is saved.

Control then returns to block 300. Control will continue to loop through blocks 300-306 until the offer developer 60 has developed and saved a possible offer for every farm still under consideration.

The Farm Selector

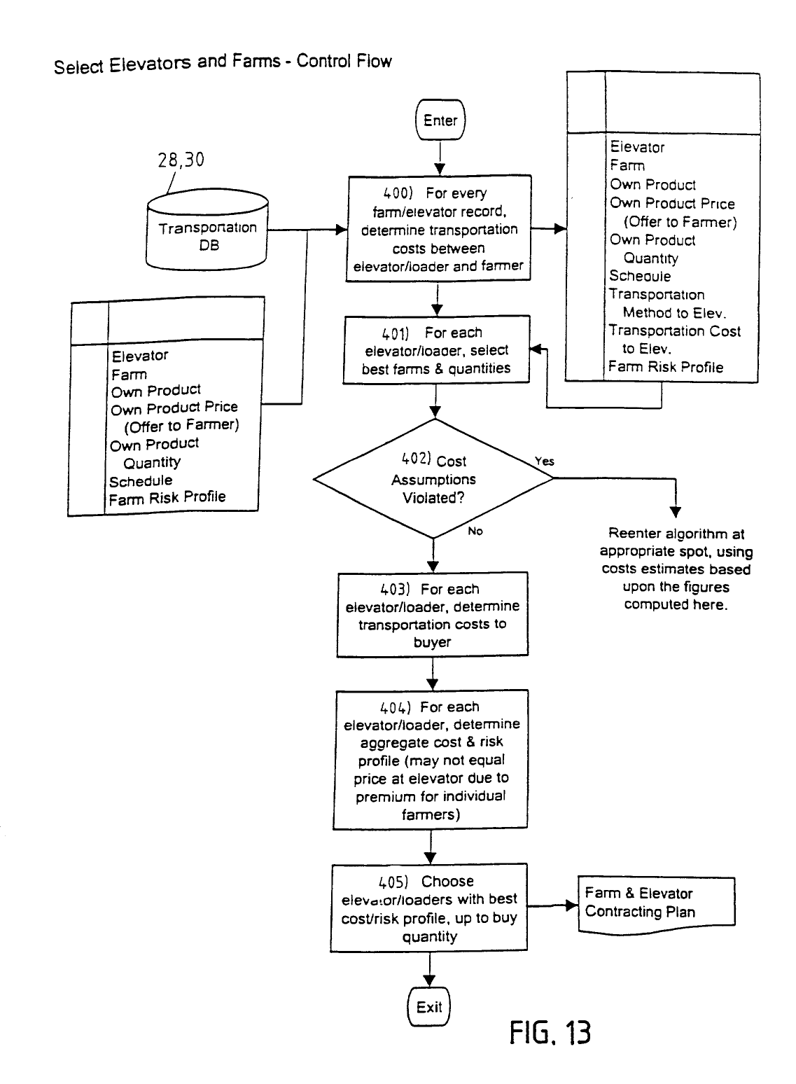

An exemplary program for implementing the farm selector 70 which determines which farms will receive an offer to participate is shown in FIG. 13. The program of FIG. 13 implements block 104 of FIG. 7B.

Prior to entry into this routine, a “record” has been created for every farm of interest. The record for each farm contains information about the elevator/loader which offers the best value to the farmer for competitive products, the price to offer to that farmer to grow the crop of interest instead of the competitive product, and other useful information.

At block 400, the farm screener 72 of the farm selector 70 determines the cost of transportation from the farm to the associated elevator/loader for each record/farm. In many cases this may be zero (farmer provided transportation). In the null elevator/loader case, the cost of transporting the product directly to the buyer is computed.

For each elevator/loader in the set of records, the farm screener 72 selects the best farm(s) to produce the crop of interest (block 401). The farms are selected based upon best value (cost, risk profile), limiting selection to elevator capacity or to buyer quantity, whichever is less.

In computing costs earlier, assumptions may have been made (e.g., transportation costs based upon volume). At block 402, the farm selector 70 tests to ensure no such assumptions were violated. If any such assumptions have been violated, the farm selector 70 aborts and the crop planner 10 begins to re-execute at the appropriate point depending on which assumption was violated (e.g., if a transportation cost assumption is incorrect, the crop planner 10 returns to the point the assumption was made, changes the assumption and restarts from that point), using cost estimates based upon the data available at block 402.

If no such assumptions were violated, control proceeds to block 403. At block 403, the elevator/loader profiler 74 of the farm selector 70 determines the transportation cost from the elevator/loader to the buyer for each elevator/loader under consideration.

The elevator/loader profiler 74 next computes the aggregate cost and risk profile for each elevator/loader under consideration based upon the selected farms and the transportation costs (block 404).

At block 405, the elevator/loader selector 76 of the farm selector 70 selects the elevator(s)/loader(s) with the best cost/risk profile and the best farm(s) associated with those elevators/loaders to supply the total buyer quantity. The farm selector 70 can then (preferably after human approval), take steps to electronically contract to execute the plan it has developed. Examples of electronic buying and selling agents capable of electronically contracting to execute the plan are disclosed in U.S. patent application Ser. No. 09/610,391 filed Jul. 5, 2000 which is hereby incorporated in its entirety by reference and will not be further described herein. These electronic agents preferably contract with farmers, stores, handlers and/or transporters via electronic exchange(s) to execute the plan. It is likely that in attempting to contract, the agents will determine that parts or whole pieces of the plan cannot be achieved with respect to the various participants (for instance, a chosen farmer may not agree to the predetermined conditions). This will necessitate a reiteration loop through the program to determine the next best alternative solution or solutions (e.g., a different farmer and/or a less costly competitive crop). This reiteration procedure continues until the solution set is met.

Finally, based on the risk factor probabilities, the crop planner 10 can optionally create a series of hedging solutions for the various contracted parts of the chain (for instance, around the climate component) by means of real time linkage to the various market instruments underlying the related probabilities. Again, these hedging actions are preferably implemented by the electronic buying and/or selling agents. Thus, for example, the crop planner may take a position in the freight market to hedge against changes in transportation rates or contract to buy a weather derivative to hedge against potential adverse impacts of unpredictable weather effects.

Economic Analysis Tool

From the foregoing, persons of ordinary skill in the art will appreciate that the disclosed apparatus and methods can be used in many ways without departing from the scope or spirit of the invention. For example, the disclosed apparatus and methods may be used as an economic analysis tool to develop information of interest to an agricultural entity such as a specialty product provider, a farmer, an animal producer, an ingredient supplier (including, for example, a money lender), and/or an animal stock provider. In other words, the disclosed apparatus and methods can be used as a predictive tool to enable parties of interest to make informed economic decisions.

By way of example, not limitation, a user of the disclosed crop planning apparatus 10 and/or methods can estimate future profits for farms in a region of interest for growing a crop of interest. In particular, the user can execute the crop planner 10 to develop a plan for the region of interest which selects farms and identifies offers for those farms as explained above without contacting the farms to implement the plan. The crop planner 10 can then sum the expected profits that the farm would earn if they agreed to contract under the plan. This sum is an estimate of the profits to be earned by the farms in the region of interest for growing the crop of interest.

Of course, because the crop planner 10 calculates the expected profits to be earned by each farm in the region of interest for growing crops competing with the crop of interest, the crop planner 10 may also optionally calculate the total profits to be earned by the farmers in the region of interest by summing the profits of all farms for all crops grown. The latter calculation can be performed once with the profits for growing the crop of interest substituted for the profits of one or more competing crops as specified by the developed plan, and once assuming the crop of interest is not grown to respectively determine (a) the expected profit of all farms in the region if the plan is accepted, and (b) the expected profit of all farms in the region if the plan is rejected. The results of these calculations ((a) and (b)) can then be compared to estimate the regional effect on farm profits for growing the crop of interest under the plan developed by the crop planner 10.

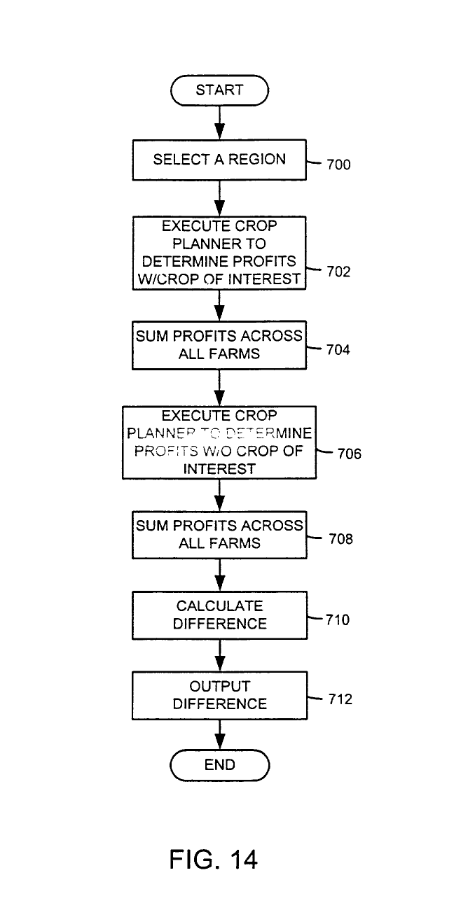

A flowchart illustrating the use of the crop planner 10 to perform the regional profitability economic analysis is shown in FIG. 14. As shown in that figure, when the crop planner 10 is used to perform this regional profitability impact analysis, the user is first requested to identify a region of interest (e.g., a country, a geographic area, a continent, the world, etc.) (Block 700) This geographic specification is used by the farm identifier 40 to develop the set of farms under analysis.

At block 702, the crop planner 10 is executed to determine the expected profit of each farm in the region of interest assuming no plan is implemented to grow the crop of interest. The profits identified by this analysis are then summed across all farms in the region of interest. (Block 704).

The crop planner 10 is then executed to develop a plan for contracting to grow a crop of interest in the region of interest as explained above in connection with FIGS. 7-13 (Block 706). The expected profits of the farms in the region of interest assuming the plan is executed are then summed across all farms (Block 708). The difference between the aggregate profits of the farm with and without the crop of interest is then computed (Block 710). This difference is output to the user (Block 712).

From the foregoing, persons of ordinary skill in the art will further appreciate that the disclosed apparatus and methods can be used as a predictive tool in many other ways without departing from the scope or spirit of the invention. For example, the apparatus and/or methods can be used to develop economic information relating to farms and derivative markets associated with farm activity and/or profitability. More specifically, as discussed above, the crop planner 10 develops a plan which identifies one or more competing products for which a crop of interest is to be substituted. If this plan is carried out, it will likely impact upon the marketplace in a number of ways. For example, it will result in a reduction of the supply of the competing products replaced by the crop of interest which could lead to a price increase for those competing products, which is possibly reflected in one or more commodity markets. It could also impact upon the transportation market by changing the product delivery needs for the region if the crop of interest has different shipment requirements than the replaced competing product(s). If there is a difference in the type or quantity of storage space needed by the crop of interest and the displaced competing product(s), the availability and, thus, the value of storage space may be impacted. Similarly, if the crop of interest and the displaced crops require different inputs (e.g., fertilizers, farming machinery, insecticides, etc.), an impact on those input markets would be expected in the form of increased or decreased demand. Additionally, if the crop of interest results in an increase in profitability for farmers in a region, the land values in that region can possibly be positively affected.

Preferably, the crop planner 10 is adapted to identify the impact(s), if any, substituting the crop of interest for the competing crop(s) will have on these areas to the user. This information is developed by comparing the aggregated inputs and outputs of the farms in the region of interest assuming the plan to grow the crop of interest is not implemented, with the corresponding aggregate inputs and outputs of the farms in that same region assuming the plan developed by the crop planner 10 is implemented. This comparison will reveal an aggregate positive, negative or zero effect on the various markets supplying and supplied by the farms in the region. These economic effect(s) can be reviewed before any contracting under the plan is initiated and, if a significant impact in one or more area (e.g., a transportation market, a commodity market, storage space, and value, etc.) will occur, market action(s) can be taken in advance (e.g. to benefit the agricultural entity executing the plan) based on the estimated economic effect(s).

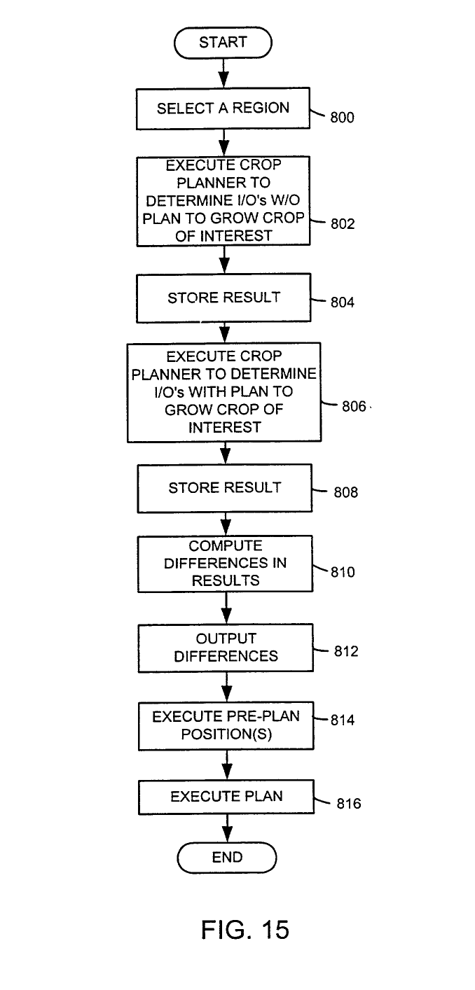

A flowchart illustrating the use of the crop planner 10 to perform the input/output economic analysis described above is shown in FIG. 15. As shown in that figure, when the crop planner 10 is used to perform such analysis, the user is first requested to identify a region of interest (e.g., a country, a geographic area, a continent, the world, etc.) (Block 800).

At block 802, the crop planner 10 is executed to determine the expected inputs and outputs of each farm in the region of interest assuming no plan is implemented to contract grow the crop of interest. The inputs and outputs of each farm in the region identified by this analysis are summed and saved (Block 804).

The crop planner 10 is then executed to develop a plan for contracting to grow the crop of interest in the region of interest as explained above in connection with FIGS. 7-13 (Block 806). The expected inputs and outputs of each farm in the region assuming the plan is executed are summed and stored (Block 808). The differences between the corresponding aggregate inputs and aggregate outputs of the farm in the region with and without the plan are then computed (Block 810). These differences in the respective aggregate inputs and aggregate outputs are output to the user (Block 812).

The user can then analyze the differences and, before executing the plan to contract farm the crop of interest, instruct the electronic buying and selling agents to take market action(s) to benefit from the impact such plan is expected to have (Block 814). After the market positions are secured, the electronic buying and selling agents are authorized to execute the plan to contract farm the crop of interest in the region of interest (Block 816) as explained above. For example, one can take a market position reflecting a belief that supply of a given commodity such as a competing crop will decrease thereby resulting in future price increase(s) of that commodity. Examples of possible market positions include selling and/or buying on a futures market, selling and/or buying on a cash market, and selling and/or buying on a derivative market. Similarly, market action can be taken to take advantage of produced changes in the demand for input(s) to a farm, changes in land value, and/or changes in the transportation market(s) expected to be caused by implementation of the plan.

Persons or ordinary skill in the art will appreciate that, as used herein, the term “computer” refers to one or more computers, and the term “database” refers to one or more databases. Similarly, referring in the singular to any other component (or step) that can be implemented by one or more components (or steps) is meant to encompass the singular and/or the plural.

As used herein, the term “farm” refers to one or more contiguous or non-contiguous plots of land capable of use to grow a product of any type. Persons of ordinary skill in the art will appreciate that two or more plots in a single farm may have the same or different environmental or geographic profiles and/or may be serviced by the same or different elevator(s)/loader(s).

Although certain apparatus constructed in accordance with the teachings of the invention have been described herein, the scope of coverage of this patent is not limited thereto. On the contrary, this patent covers all embodiments of the teachings of the invention fairly falling within the scope of the appended claims either literally or under the doctrine of equivalents.

What is claimed is:

1. An apparatus for selecting farms to grow a crop of interest comprising:
a database;
a farm identifier in communication with the database to develop a set of farms capable of growing the crop of interest;
a competition analyzer cooperating with the farm identifier to estimate profits to be earned by farms in the set of farms for growing at least one crop which is different from the crop of interest;
an offer developer cooperating with the competition analyzer to determine possible offers to be made to the farms in the set of farms based at least in part upon the estimated profits to be earned for growing the at least one crop which is different from the crop of interest; and
a farm selector cooperating with the offer developer to select farms from the set of farms to receive an offer to grow the crop of interest.

2. An apparatus as defined in claim 1 wherein the farm selector selects farms based upon at least one of: the estimated profits developed by the offer developer, risk estimations associated with the farms in the set of farms, profit to be earned by an agricultural company, price to be charged consumers, transportation cost for transporting the crop of interest from a farm to a predefined location; transportation cost for transporting the crop of interest from a farm to a loader; transportation cost for transporting the crop of interest from a farm to an elevator; transportation cost for transporting the crop of interest from an elevator to the predefined location; transportation cost for transporting the crop of interest from a loader to the predefined location; aggregate economic profiles of elevators associated with the farms in the set of farms; and aggregate economic profiles of loaders associated with the farms in the set of farms.

3. An apparatus as defined in claim 1 wherein the farm identifier identifies the set of farms based upon at least one of: elevator capability to handle the crop of interest, loader capability to handle the crop of interest, farm capability to grow the crop of interest, farm capability to grow a predefined quantity of the crop of interest, and farm capability to grow the crop of interest within a predetermined schedule.

4. An apparatus as defined in claim 1 wherein the database comprises at least one of: (a) a product database containing data indicative of types of products that may be grown by a farm, (b) an elevator database containing data indicative of types and quantities of products that may be handled by an elevator; (c) a loader database containing data indicative of types and quantities of products that may be handled by a loader; (d) a product market database containing data indicative of sales prices of types of products; (e) a transportation market database containing data indicative of transportation costs for transporting goods between geographic locations; (f) a transportation database containing data indicative of types of transportation available for transporting a product from at least one of a farm, an elevator and a loader; and (g) a farm database containing data indicative of at least one of agronomic characteristics of a farm and geographic information concerning a farm.

5. An apparatus as defined in claim 4 wherein at least one of the at least one database comprises an on-line database.

6. An apparatus as defined in claim 4 wherein at least one of the at least one database comprises a local database.

7. An apparatus as defined in claim 5 wherein the on-line database comprises an on-line exchange.

8. An apparatus as defined in claim 1 wherein the farm identifier further comprises:
an elevator/loader discriminator for developing the set of farms by identifying elevators/loaders that cannot handle the crop of interest; and
a farm discriminator cooperating with the elevator/loader discriminator for developing the set of farms by eliminating farms that are associated with only elevators/loaders identified by the elevator/loader discriminator from the set of farms and by eliminating farms that cannot grow the crop of interest from the set of farms.

9. An apparatus as defined in claim 1 wherein the competition analyzer further comprises:
a profit estimator for estimating a profit that a farm in the set of farms can expect to earn by growing the at least one crop which is different from the crop of interest; and
a product selector cooperating with the profit estimator to select a most profitable crop for the farm from the at least one crop which is different from the crop of interest.

10. An apparatus as defined in claim 1 wherein the offer developer further comprises:
a production estimator in communication with the database for estimating a quantity of the crop of interest to be produced by a farm of interest in the set of farms; and
a pricing engine cooperating with the production estimator to develop a price to be offered the farm of interest to grow the quantity of the crop of interest estimated by the production estimator.

11. An apparatus as defined in claim 10 wherein the offer developer further comprises a risk identifier in communication with the database for identifying a risk factor associated with the farm of interest, wherein the pricing engine develops the price to be offered the farm of interest to grow the quantity of the crop of interest estimated by the production estimator based at least in part upon the risk factor.

12. An apparatus as defined in claim I the farm selector further comprises:
a farm screener in communication with the database for selecting a preferred set of farms from the set of farms based on at least one of: (i) a risk factor, (ii) an expected profit, and (iii) an expected quantity;
an elevator/loader profiler for developing an aggregate economic profile for each elevator/loader associated with a farm in the preferred set of farmers; and
an elevator/loader selector for selecting farms to receive an offer to grow the crop of interest based on the aggregate economic profiles developed by the elevator/loader profiler and the quantity of the crop of interest to be grown.

13. An apparatus as defined in claim 1 wherein the competition analyzer estimates the profits to be earned by farms in the set of farms for growing the at least one crop which is different from the crop of interest based upon at least one current market price.

14. An apparatus as defined in claim 1 wherein, for a farm in question associated with more than one elevator/loader, the offer developer determines the possible offer based upon the elevator/loader with a highest relative profit to be earned by the farm in question.

15. An apparatus as defined in claim 1 wherein the offer developer determines the possible offers based in part upon at least one risk factor and profits to be earned by the farms in growing the crop of interest.

16. An apparatus as defined in claim 2 wherein the aggregate economic profiles of the elevators are based at least in part upon cost and risk associated with the farms associated with the elevators.

17. An apparatus as defined in claim 2 wherein the aggregate economic profiles of the loaders are based at least in part upon cost and risk associated with the farms associated with the loaders.

18. A method for selecting farms to grow a crop of interest comprising the steps of:
developing a set of farms capable of growing the crop of interest;
estimating profits to be earned by farms in the set of farms for growing at least one crop which is different from the crop of interest;
determining possible offers to be made to the farms in the set of farms based at least in part upon the estimated profits to be earned for growing the at least one crop which is different from the crop of interest; and
selecting farms from the set of farms to receive an offer to grow the crop of interest.

19. A method as defined in claim 18 wherein the step of selecting farms is based upon at least one of: the estimated profits developed by the offer developer, risk estimations associated with the farms in the set of farms, profit to be earned by an agricultural company, price to be charged consumers, transportation cost for transporting the crop of interest from a farm to a predefined location; transportation cost for transporting the crop of interest from a farm to a loader; transportation cost for transporting the crop of interest from a farm to an elevator; transportation cost for transporting the crop of interest from an elevator to the predefined location; transportation cost for transporting the crop of interest from a loader to the predefined location; aggregate economic profiles of elevators associated with the farms in the set of farms; and aggregate economic profiles of loaders associated with the farms in the set of farms.

20. A method as defined in claim 18 wherein the step of developing the set of farms is performed by considering at least one of: elevator capability to handle the crop of interest, loader capability to handle the crop of interest, farm capability to grow the crop of interest, farm capability to grow a predefined quantity of the crop of interest, and farm capability to grow the crop of interest within a predetermined schedule.

21. A method as defined in claim 18 wherein the step of developing the set of farms is performed by accessing a database.

22. A method as defined in claim 21 wherein the database comprises at least one of: (a) a product database containing data indicative of types of products that may be grown by a farm, (b) an elevator database containing data indicative of types and quantities of products that may be handled by an elevator; (c) a loader database containing data indicative of types and quantities of products that may be handled by a loader; (d) a product market database containing data indicative of sales prices of types of products; (e) a transportation market database containing data indicative of transportation costs for transporting goods between geographic locations; (f) a transportation database containing data indicative of types of transportation available for transporting a product from at least one of a farm, an elevator and a loader; and (g) a farm database containing data indicative of at least one of agronomic characteristics of a farm and geographic information concerning a farm.

23. A method as defined in claim 22 wherein at least one of the at least one database comprises an on-line database.

24. A method as defined in claim 22 wherein at least one of the at least one database comprises a local database.

25. A method as defined in claim 23 wherein the on-line database comprises an on-line exchange.

26. A method as defined in claim 18 wherein the step of developing the set of farms further comprises the steps of:
identifying elevators/loaders that cannot handle the crop of interest;
eliminating farms from the set of farms that are associated with only the elevators/loaders that cannot handle the crop of interest; and
eliminating farms that cannot grow the crop of interest from the set of farms.

27. A method as defined in claim 18 wherein the step of estimating profits further comprises the steps of:
estimating a profit that a farm in the set of farms can expect to earn by growing the at least one crop which is different from the crop of interest; and
selecting a most profitable crop for the farm from the at least one crop which is different from the crop of interest.

28. A method as defined in claim 18 wherein the step of determining possible offers further comprises the steps of:
estimating a quantity of the crop of interest to be produced by a farm of interest in the set of farms; and
developing a price to be offered the farm of interest to grow the estimated quantity of the crop of interest.

29. A method as defined in claim 28 wherein the step of determining possible offers further comprises the steps of:
identifying a risk factor associated with the farm of interest; and
adjusting the price to be offered the farm of interest to grow the quantity of the crop of interest based at least in part upon the risk factor.

30. A method as defined in claim 18 wherein the step of selecting farms further comprises the steps of:
selecting a preferred set of farms from the set of farms based on at least one of: (i) a risk factor, (ii) an expected profit, and (iii) an expected quantity;
developing an aggregate economic profile for each elevator/loader associated with a farm in the preferred set of farms; and
selecting farms to receive an offer to grow the crop of interest based on the developed aggregate economic profiles and the quantity of the crop of interest to be grown .

31. A method as defined in claim 18 wherein the step of estimating profits further comprises the step of estimating the profits to be earned by farms in the set of farms for growing the at least one crop which is different from the crop of interest based upon at least one current market price.

32. A method as defined in claim 18 wherein, for a farm in question associated with more than one elevator/loader, the step of determining possible offers comprises determining the possible offer based upon the elevator/loader with a highest relative profit to be earned by the farm in question.

33. A method as defined in claim 18 wherein the step of determining possible offers is based in part upon at least one risk factor and profits to be earned by the farms in growing the crop of interest.

34. A method as defined in claim 19 wherein the aggregate economic profiles of the elevators are based at least in part upon cost and risk associated with the farms associated with the elevators.

35. A method as defined in claim 19 wherein the aggregate economic profiles of the loaders are based at least in part upon cost and risk associated with the farms associated with the loaders.

36. A method for estimating future profits for farms in a region of interest for growing a crop of interest, the method comprising the steps of:
identifying farms in the region of interest;
electronically accessing at least one on-line market to ascertain at least one current market price for at least one product different than the crop of interest;
determining projected profits to each of the farms in the region of interest for growing products different than the crop of interest based at least partially on the at least one current market price;
selecting at least one of the products to be replaced by the crop of interest on at least some of the farms in the region of interest;
determining profits to be earned by the at least some of the farms for growing the crop of interest; and
summing the profits to be earned by the farms in the region of interest for growing the crop of interest.

37. An apparatus for determining a price to offer a farmer to grow a crop of interest comprising:
a database containing current market price data for crops which are different from the crop of interest;
a profit estimator in communication with the database for estimating a profit that the farmer can expect to earn by growing at least one of the crops which are different from the crop of interest;
a product selector cooperating with the profit estimator to select a crop from the at least one of the crops which are different from the crop of interest;
a production estimator cooperating with the product selector for estimating a quantity of the crop of interest to be produced by a farmer on acreage associated with the crop selected by the product selector; and
a pricing engine cooperating with the production estimator to develop a price to be offered the farmer of interest to grow the quantity of the crop of interest estimated by the production estimator based at least in part on the profit that the farmer can expect to earn by growing the crop selected by the product selector.

38. A method for determining a price to offer a farmer to grow a crop of interest comprising the steps of:
accessing a database containing current market price data for crops which are different from the crop of interest;
estimating a profit that the farmer can expect to earn by growing at least one of the crops which are different from the crop of interest;
selecting a crop from the at least one of the crops which are different from the crop of interest;
estimating a quantity of the crop of interest to be produced by a farmer on acreage associated with the selected crop; and
developing a price to be offered the farmer of interest to grow the estimated quantity of the crop of interest based at least in part on the profit that the farmer can expect to earn by growing the selected crop which is different than the crop of interest.

39. A method as defined in claim 38 wherein the step of developing a price further comprises the steps of:
identifying a risk factor associated with the farmer of interest; and
adjusting the price to be offered the farmer of interest to grow the quantity of the crop of interest based at least in part upon the risk factor.

40. A method for developing economic information relating to activities of farms comprising the steps of:
identifying farms capable of growing a crop of interest;
electronically accessing at least one on-line market to ascertain at least one current market price for at least one product different than a crop of interest;
determining projected profits to the identified farms for growing at least one product different than the crop of interest based at least partially upon the at least one current market price;
selecting at least one of the products to be replaced by the crop of interest on at least some of the identified farms based at least in part upon the projected profits;
estimating an economic effect that substituting the crop of interest for the at least one of the products will have on at least one of: (a) a transportation market; (b) a commodity market; (c) demand for storage space; (d) land usage; (e) a price of at least one of the at least one of the products; (f) supply of at least one product; (g) demand for at least one input to a farm;.

41. A method as defined in claim 40 further comprising the step of taking market action based upon the estimated economic effect.

42. A method as defined in claim 40 wherein the commodity market is associated with at least one of the at least one of the products to be replaced by the crop of interest.

43. A method for securing a resource for growing crops comprising the steps of:
developing a set of farms capable of growing a crop of interest;
estimating profits to be earned by farms in the set of farms for growing at least one crop which is different from the crop of interest;
analyzing at least one of the estimated profits and estimated yields of the farms to identify an undervalued resource; and
taking market action to secure the identified undervalued resource.

44. A method as defined in claim 43 wherein the undervalued resource comprises at least one of land and storage space.

45. A method for reducing risk associated with contracting to growing a crop of interest comprising the steps of:
identifying farms capable of growing a crop of interest;
electronically accessing at least one on-line market to ascertain at least one current market price for at least one product different than a crop of interest;
determining projected profits to each of the identified farms for growing products different than the crop of interest based at least partially upon the at least one current market price;
selecting at least one of the products to be replaced by the crop of interest on at least some of the identified farms based at least in part upon the projected profits; and
selecting a subset of the identified farms to grow the crop of interest based on the profit that the identified farms can expect to earn by growing the crop which is replaced by the crop of interest and upon at least one risk associated with the geographic location of the identified farms.

46. A method as defined in claim 45 wherein the at least one risk comprises at least one of weather risk and logistics risk.

47. A method for managing inventory relating to growing a crop of interest to an agricultural entity comprising the steps of:
identifying farms capable of growing the crop of interest;
selecting farms from the identified farms to grow the crop of interest;
contracting with at least some of the selected farms to grow the crop of interest; and
managing the inventory based at least in part on contractual commitments made by the selected farms.

48. A method as defined in claim 41 wherein the market action is taken by at least one of an electronic buying agent and an electronic selling agent.

49. An apparatus as defined in claim I wherein the database is at least partially populated by a software agent which is programmed to locate and retrieve data of interest from a networked device.

50. An apparatus as defined in claim 49 wherein the apparatus is coupled to the networked device via the Internet.

51. A method for estimating an effect growing a crop of interest will have on a region of interest comprising the steps of:
identifying farms in the region of interest which are capable of growing the crop of interest;
determining a first set of aggregated projected inputs and outputs of the farms in the region of interest for growing products different than the crop of interest;
selecting at least one of the products to be replaced by the crop of interest on at least some of the farms in the region of interest;
determining a second set of aggregated projected inputs and outputs of farms in the region of interest assuming the at least some of the farms replace the at least one of the products with the crop of interest; and
computing a difference between the first and second sets of aggregated inputs and outputs to estimate at least one effect growing the crop of interest will have on the region of interest.
